(19) United States
(12) Patent Application Publication
(10) Pub. No.: US 2014/0278577 A1
(43) Pub. Date: Sep. 18, 2014

(54) SYSTEM AND METHOD FOR GENERATING INSURANCE PREMIUM QUOTES

(71) Applicants: Philip Baum, Columbus, OH (US); Yvonne Brooks, Columbus, OH (US); Dana Halicki, Columbus, OH (US); David Johnson, Columbus, OH (US); Tim Wallick, Columbus, OH (US); Jane Wichman, Columbus, OH (US)

(72) Inventors: Philip Baum, Columbus, OH (US); Yvonne Brooks, Columbus, OH (US); Dana Halicki, Columbus, OH (US); David Johnson, Columbus, OH (US); Tim Wallick, Columbus, OH (US); Jane Wichman, Columbus, OH (US)

(73) Assignee: Grange Insurance, Columbus, OH (US)

(21) Appl. No.: 14/204,147

(22) Filed: Mar. 11, 2014

Related U.S. Application Data
(60) Provisional application No. 61/780,022, filed on Mar. 13, 2013.

(51) Int. Cl. G06Q 40/08

(52) U.S. Cl. CPC G06Q 40/08
USPC 705/4

(57) ABSTRACT

A computerized system and method for generating insurance premium quotes that operates in the environment of a comparative rater application and that provides variable or adjustable quotes for insurance policy premiums to a user of the comparative rater application.

### CROSS-REFERENCE TO RELATED APPLICATIONS

This patent application claims the benefit of U.S. Provisional Patent Application Ser. No. 61/780,022 filed on Mar. 13, 2013 and entitled “Adjustable or Alternative Insurance Rate Quoting,” the disclosure of which is hereby incorporated by reference herein in its entirety and made part of the present U.S. utility patent application for all purposes.

### BACKGROUND OF THE INVENTION

The described invention relates in general to a system and method for generating insurance premium quotes, and more specifically to a computerized method that operates in the environment of a comparative rater application and that provides variable quotes for insurance policy premiums to a user of the comparative rater.

A comparative rater is an insurance software tool that is used for rating a specified insurance risk across multiple competing insurance carriers and then displaying a variety of rate quotes for that insurance risk. Comparative rating software is typically used by independent insurance agents and personal property and casualty carriers for use in rating insurance risks. Independent insurance agents are able to rate prospective insurance applicants using a comparative rater and then determine what premium or premiums for purchasing insurance are offered to that applicant. Personal property and casualty carriers also use comparative raters to gather rate information and conduct market analysis. Comparative rating software also applies carrier underwriting rules, surcharges and discounts on the insurance risk during rating. Comparative rating software is currently available in two forms; (i) PC-based comparative rating software, which is a computer application locally installed on a computer; and (ii) Internet-based comparative rating software that is accessible on the Internet through a web browser. When in use, the comparative rater typically displays insurance rate quotes and discounts from a plurality of competitive insurance providers on a single web page.

The information displayed on a comparative rater with regard to premium quotes is typically static data that cannot be changed or otherwise manipulated once it is displayed to a user of the system. Because this information cannot be changed, the agent using the comparative rater is not able to query individual insurance providers through the comparative rater with regard to obtaining alternate premium quotes based on proposed changes or modifications to certain aspects of the insurance policies being offered. This aspect of comparative raters makes these applications somewhat limited in their usefulness for obtaining truly competitive quotes for insurance policy premiums; thus, there is an ongoing need for a computerized system for allowing comparative rater applications to be more interactive, more dynamic, and to provide adjustable or alternative premium quotes.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a system for generating variable and/or adjustable quotes for insurance premiums and providing those quotes to a customer applying for insurance coverage is provided. This system includes a first computer that further includes a first computerized database that further includes tiered customer profiles that are based on standardized customer characteristics and on certain predetermined insurance agent-specific criteria; a second computer in communication with the first computer that is used to acquire customer-specific information, wherein the customer-specific information further includes desired insurance policy coverage options, and wherein the customer-specific information is acquired from data entered into a comparative rater application running on the second computer; a first data filter running on the first computer, wherein the first data filter is applied to the acquired customer-specific information, and wherein the first data filter is operative to provide an initial determination of customer desirability; a second data filter running on the first computer, wherein the second data filter is applied to the acquired customer-specific information, and wherein the second data filter is operative to provide an initial determination of customer eligibility; a second computerized database, wherein the second computerized database is resident on or accessible by the first computer, and wherein the second computerized database further includes additional customer-specific information; a first premium quote, wherein the first premium quote is generated on the comparative rater based on the initial determinations of customer desirability and eligibility; at least one algorithm running on the first computer, wherein the at least one algorithm is operative to create a customer-specific profile, wherein the customer-specific profile is derived from the acquired customer-specific information and agent-specific criteria, and wherein the algorithm is further operative to compare the customer-specific profile to the set of tiered customer profiles to further determine customer fit; and an interstitial webpage running on the second computer, wherein the interstitial webpage is viewable by an individual using the comparative rater application, wherein the interstitial webpage is operative to provide subsequent premium quote variations, wherein the subsequent premium quote variations are based on customer fit as determined by the comparison of the customer-specific profile to the set of tiered customer profiles; and wherein the interstitial webpage is further operative to facilitate closing the sale of an insurance policy, wherein the policy premiums for the policy are selected from the subsequent premium quote variations.

In accordance with another aspect of the present invention, a first computerized method for generating variable and/or adjustable quotes for insurance premiums and providing those quotes to a customer applying for insurance coverage is provided. This method includes the following steps: (i) within a computerized database, creating tiered customer profiles, wherein each customer profile is based on standardized customer characteristics and on certain predetermined agent-specific criteria; (ii) acquiring customer-specific information, wherein the customer-specific information further includes desired insurance policy coverage options, and wherein the customer-specific information is acquired from data entered into a comparative rater application; (iii) applying at least one filter to the acquired customer-specific information, wherein the at least one filter is operative to provide an initial determination of customer desirability; (iv) applying at least one filter to the acquired customer-specific information, wherein at least one filter is functioning to provide an initial determination of customer eligibility; (v) acquiring additional customer-specific information, wherein the customer-specific information is acquired from at least one database external to the comparative rater application; (vi) offering a first premium quote on the comparative rater based on the initial determinations of customer desirability and eligibility; (vii) using at least one algorithm to create a customer-specific profile, wherein the customer-specific profile is derived from the acquired customer-specific information and agent-specific criteria; (viii) comparing the customer-specific profile to the set of tiered customer profiles to further determine customer fit; (ix) providing an interstitial webpage, wherein the interstitial webpage is viewable by an individual using the comparative rater application; (x) providing subsequent premium quote variations on the interstitial webpage, wherein the subsequent premium quote variations are based on customer fit as determined by the comparison of the customer-specific profile to the set of tiered customer profiles; and (xi) optionally, closing the sale of an insurance policy, wherein the policy premiums for the insurance policy are selected from the subsequent premium quote variations.

In yet another aspect of this invention, a second computerized method for generating variable and/or adjustable quotes for insurance premiums and providing those quotes to a customer applying for insurance coverage is provided. This method includes the following steps: (i) within a computerized database, creating tiered customer profiles, wherein each customer profile is based on standardized customer characteristics and on certain predetermined agent-specific criteria, and wherein the tiered customer profiles are operative to provide a determination of insurance policy coverage options; level of insurance risk; likelihood of insurance policy issuance; expected longevity of an insurance policy; or combinations thereof; (ii) acquiring customer-specific information, wherein the customer-specific information further includes desired insurance policy coverage options, and wherein the customer-specific information is acquired from data entered into a comparative rater application; (iii) applying at least one filter to the acquired customer-specific information, wherein the at least one filter is operative to provide an initial determination of customer desirability; (iv) applying at least one filter to the acquired customer-specific information, wherein at least one filter is functioning to provide an initial determination of customer eligibility; (v) acquiring additional customer-specific information, wherein the additional customer-specific information relates directly to the individual customer seeking insurance coverage and further includes information obtained from one or more external sources that is then used to create an insurance score for that customer, and wherein that insurance score is used in calculating a first premium quote; (vi) offering a first premium quote on the comparative rater based on the initial determinations of customer desirability and eligibility; (vii) using at least one algorithm to create a customer-specific profile, wherein the customer-specific profile is derived from the acquired customer-specific information and agent-specific criteria; and wherein the at least one algorithm leverages the standardized customer characteristics, agent-specific criteria and additional customer-specific information to score an applicant for identifying suitable coverage options; (viii) comparing the customer-specific profile to the set of tiered customer profiles to further determine customer fit; (ix) providing an interstitial webpage, wherein the interstitial webpage is viewable by an individual using the comparative rater application; (x) providing subsequent premium quote variations on the interstitial webpage, wherein the subsequent premium quote variations are based on customer fit as determined by the comparison of the customer-specific profile to the set of tiered customer profiles; and (xi) optionally, closing the sale of an insurance policy, wherein the policy premiums for the insurance policy are selected from the subsequent premium quote variations.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a flow chart of an exemplary embodiment of the present invention illustrating the process by which variable insurance premium quotes are generated.

### DETAILED DESCRIPTION OF THE INVENTION

Exemplary embodiments of the present invention are now described with reference to the Figures. Reference numerals are used throughout the detailed description to refer to the various elements and structures, where appropriate. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

As previously indicated, the present invention relates in general to a system and method for generating insurance premium quotes. More specifically, this invention provides a computerized system and associated method that operates in the environment of a comparative rater application and that provides variable quotes for insurance policy premiums to a user of the comparative rater.

In an exemplary embodiment, the system of this invention generates variable or adjustable quotes for insurance premiums and provides those quotes to a customer applying for insurance coverage. As will be appreciated by one of ordinary skill in the art, the term “customer” is synonymous with an “applicant” for receiving insurance coverage. The quotes are typically provided to the customer through an insurance agent, but in some instances, the customer may receive the quotes directly. This system includes a first computer that further includes a first computerized database that further includes various tiered customer profiles that are based on standardized customer characteristics and on certain predetermined insurance agent-specific criteria. With regard to this invention, the term “computer” will be understood to mean computers, computer-like devices, computer terminals, peripheral devices, and one or more servers that are connected to and are in communication with the Internet or other internal and external networks. The tiered customer profiles are based on a variety of known or predetermined customer characteristics and are used to rank customers into groups or tiers (i.e., from “most desirable” to “least desirable”) for purposes of determining insurance policy coverage options; level of insurance risk; likelihood of insurance policy issuance; expected longevity of an insurance policy; and other factors. Standardized customer characteristics are typically derived from compiled historical information that is not specific to a particular customer and that further includes, for example, the age of a person applying for coverage; the current limits of insurance coverage for a person applying for coverage; the number of vehicles to be insured; the number of drivers to be listed on a policy; the type of coverage requested; the replacement value of a home; or combinations thereof. Other variables, factors, or data points may also be used in creating standardized customer characteristics. Predetermined agent criteria typically further includes, for example, the number of new insurance policies written in a known period of time; the profile of new business policies issued by a particular insurance company; the ratio of new policies bound by the agent relative to quotes submitted to a particular insurance company over a known period of time; or combinations thereof. The predetermined agent criteria may include other variable, factors, or data points.

The system of this invention also includes a second computer in communication with the first computer, wherein the second computer is used to acquire customer-specific information, wherein the customer-specific information further includes desired insurance policy coverage options, and wherein the customer-specific information is acquired from data entered into a comparative rater application running on the second computer. The customer specific-information relates directly to the individual customer seeking insurance coverage and further includes, for example: the age of the person applying for coverage; the current limits of insurance coverage for the person applying for coverage; the number of vehicles to be insured; the number of drivers to be listed on a policy; the type of coverage requested; the replacement value of a home; or combinations thereof. Customer specific-information may include other variables, factors, or data points. A first data filter running on the first computer is applied to the acquired customer-specific information for providing an initial determination of customer desirability. If the policy being sought is an automobile policy, the initial determination of customer desirability may include, for example, a determination of the number of vehicles being insured; the type of coverage and limits selected; or combinations thereof. The determination of desirability may be based on these factors or other relevant or predetermined factors. A second data filter running on the first computer is also applied to the acquired customer-specific information for providing an initial determination of customer eligibility. If the policy being sought is an automobile policy, the initial determination of customer eligibility may include, for example, a determination of an insured's age, number and type of vehicles being rated, coverage limits, prior insurance history, driving record, garaging location, or combinations thereof. The determination of eligibility may be based on these factors or other relevant or predetermined factors.

The system of this invention also includes a second computerized database that is resident on or accessible by the first computer and that further includes additional customer-specific information. The additional customer-specific information relates directly to the individual customer seeking insurance coverage and includes information obtained from one or more external databases or other sources that is used to create an insurance score for the customer and that insurance score is used in calculating a first premium quote, which is generated on the comparative rater based on the initial determinations of customer desirability and eligibility. At least one algorithm is run on the first computer for creating a customer-specific profile that is derived from the acquired customer-specific information and agent-specific criteria. The customer-specific profile may include likely coverage options; level of insurance risk; likelihood of policy issuance; expected longevity of the policy; or combinations thereof. Other variables, factors, or data points may be used in creating the customer-specific profile. The algorithm compares the customer-specific profile to the set of tiered customer profiles to further determine customer fit, which is defined as an acceptable alignment between the agent, the customer (applicant), and the policy-issuing insurance company; and the algorithm leverages the standardized customer characteristics, agent-specific criteria and additional customer-specific information to score an applicant for identifying suitable coverage options. An interstitial webpage (e.g., a splash screen) is then provided on the second computer and is viewable by an individual using the comparative rater application. The interstitial webpage is operative to provide subsequent premium quote variations that are based on customer fit as determined by the comparison of the customer-specific profile to the set of tiered customer profiles. The interstitial webpage is further operative to facilitate closing the sale of an insurance policy (i.e., binding coverage), wherein the policy premiums for the policy are selected from the subsequent premium quote variations. The interstitial web page is a dynamic environment, wherein coverage options and premium offerings may be manipulated and changed by a user of the system of the present invention (i.e., the insurance agent).

In an another exemplary embodiment, the computerized method of this invention generates variable or adjustable quotes for insurance premiums and provides those quotes to a customer applying for insurance coverage. As previously indicated, this method, which may be executed partially or wholly in an automated manner, includes the following steps: (i) within a computerized database, creating tiered customer profiles, wherein each customer profile is based on standardized customer characteristics and on certain predetermined agent-specific criteria; (ii) acquiring customer-specific information, wherein the customer-specific information further includes desired insurance policy coverage options, and wherein the customer-specific information is acquired from data entered into a comparative rater application; (iii) applying at least one filter to the acquired customer-specific information, wherein the at least one filter is operative to provide an initial determination of customer desirability; (iv) applying at least one filter to the acquired customer-specific information, wherein at least one filter is functioning to provide an initial determination of customer eligibility; (v) acquiring additional customer-specific information, wherein the customer-specific information is acquired from at least one database external to the comparative rater application; and wherein the additional customer-specific information is used to create an insurance score for the customer, and wherein that insurance score is used in calculating the first premium quote; (vi) offering a first premium quote on the comparative rater based on the initial determinations of customer desirability and eligibility; (vii) using at least one algorithm to create a customer-specific profile, wherein the customer-specific profile is derived from the acquired customer-specific information and agent-specific criteria, and wherein the at least one algorithm leverages the standardized customer characteristics, agent-specific criteria, and acquired customer-specific information to score an applicant for identifying suitable coverage options; (viii) comparing the customer-specific profile to the set of tiered customer profiles to further determine customer fit; (ix) providing an interstitial webpage, wherein the interstitial webpage is viewable by an individual using the comparative rater application; (x) providing subsequent premium quote variations on the interstitial webpage, wherein the subsequent premium quote variations are based on customer fit as determined by the comparison of the customer-specific profile to the set of tiered customer profiles; and (xi) optionally, closing the sale of an insurance policy, wherein the policy premiums for the insurance policy are selected from the subsequent premium quote variations.

With regard to the method of the present invention, the insurance policy may be an automobile policy, a homeowner's policy, or any other type of insurance policy. The tiered customer profiles are operative to provide a determination of insurance policy coverage options; level of insurance risk; likelihood of insurance policy issuance; expected longevity of an insurance policy; or combinations thereof. The standardized customer characteristics are derived from compiled historical information that is not specific to a particular customer and that further includes: age of a person applying for coverage; current limits of insurance coverage for a person applying for coverage; number of vehicles to be insured; number of drivers to be listed on a policy; type of coverage requested; replacement value of a home; or combinations thereof. Other variables, factors, or data points may also be used in creating standardized customer characteristics. The predetermined agent criteria may further include the number of new insurance policies written in a known period of time; the profile of new business policies issued by a particular company; the ratio of new policies bound by the agent relative to quotes submitted to a particular company over a known period of time; or combinations thereof. The predetermined agent criteria may also include other variable, factors, or data points. The customer specific-information relates directly to the individual customer seeking insurance coverage and further includes, for example: the age of the person applying for coverage; the current limits of insurance coverage for the person applying for coverage; the number of vehicles to be insured; the number of drivers to be listed on a policy; the type of coverage requested; the replacement value of a home; or combinations thereof. Customer specific-information may include other variables, factors, or data points. The initial determination of customer desirability may include a determination of the number of vehicles being insured; the type of coverage and limits selected; or combinations thereof. The determination of desirability may be based on these factors or other relevant or predetermined factors. The initial determination of customer eligibility typically includes a determination of an insured's age, number and type of vehicles being rated, coverage limits, prior insurance history, driving record, garaging location, or combinations thereof. The determination of eligibility may be based on these factors or other relevant or predetermined factors. The additional customer-specific information may include information obtained from one or more external sources that is used to create an insurance score for the customer, and wherein that insurance score is used in calculating the first premium quote. The at least one algorithm leverages the standardized customer characteristics, agent-specific criteria, and acquired customer-specific information to score an applicant for identifying suitable coverage options. Finally, the customer-specific profile includes likely coverage options; level of insurance risk; likelihood of policy issuance; expected longevity of the policy; or combinations thereof. Other variables, factors, or data points may be used in creating the customer-specific profile.

FIG. 1 provides a flow chart of another exemplary embodiment of the present invention and illustrates a decisional process by which variable insurance premium quotes are generated on a comparative rater application. With reference to FIG. 1, at step 10, an agent accesses a comparative rater. At step 20, the agent enters customer data. At step 30 the comparative rater sends an XML quote request to participating insurance carriers with the customer data for rating. At step 40 a determination is made as to whether or not the risk associated with the customer meets the desirability review. If the risk does not meet the desirability review, at step 50, the request is rejected and a response is sent back to the comparative rater with messaging; and at step 60 the agent may adjust the customer data. If the agent does adjust the customer data, at step 70 the agent resubmits the revised customer data for rating and then returns to step 30. If the agent does not adjust the customer data, the process ends at step 80 because the risk has not meet the desirability requirements. If the risk does meet the desirability review, at step 90, a determination is made as to whether or not the risk associated with the customer meets the eligibility review. If the risk does not meet the eligibility review, at step 100, the rate is aborted and a response is sent back to the comparative rater with messaging; and at step 110, the process ends because the risk does not meet minimum eligibility requirements. If the risk does meet the eligibility review, at step 120 an insurance score is ordered. At step 130, a premium quote is calculated, at step 140 a customer-specific profile is created, at step 150 customer fit is determined, and at step 160 premium quote variations are calculated and stored based on customer fit. When a premium quote is calculated at step 130, the system responds back to the comparative rater at step 170 with an XML response file containing premium, coverage details, remarks, and a link to the interstitial webpage. If the agent does not click the link to view the interstitial webpage at step 180, the quote process ends at step 290. If the agent does click the link to view the interstitial webpage at step 180, then at step 190 stored premium quote variations are accessed, at step 200 subsequent premium quote variations are presented on the interstitial webpage, and then at step 210, one of three options to close the sale of an insurance policy is offered based on predefined criteria. At step 220, Option 1 is to bind coverage from the interstitial webpage. At step 230, Option 2 is to request additional customer-specific information from an external database within the interstitial webpage, at step 240 the agent requests additional report orders, at step 250, the carrier orders external data and reevaluates fit, and at step 260 based on the additional data, a determination of optimal fit is made. If fit is optimal, at step 270 coverage is bound from the interstitial webpage. If fit is not optimal, at step 280, which is also Option 3, a link is provided to the carrier agent portal to continue the quote process, application process, and coverage binding process. FIG. 1 is one example of how the method of the present invention may be executed and numerous other variants of this process are possible.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A system for generating variable or adjustable quotes for insurance premiums and providing those quotes to a customer applying for insurance coverage, comprising:
(a) a first computer, wherein the first computer further includes a first computerized database, wherein the first computerized database further includes tiered customer profiles, and wherein each customer profile is based on standardized customer characteristics and on certain predetermined insurance agent-specific criteria;
(b) a second computer in communication with the first computer, wherein the second computer is used to acquire customer-specific information, wherein the customer-specific information further includes desired insurance policy coverage options, and wherein the customer-specific information is acquired from data entered into a comparative rater application running on the second computer;
(c) a first data filter running on the first computer, wherein the first data filter is applied to the acquired customer-specific information, and wherein the first data filter is operative to provide an initial determination of customer desirability;
(d) a second data filter running on the first computer, wherein the second data filter is applied to the acquired customer-specific information, and wherein the second data filter is operative to provide an initial determination of customer eligibility;
(e) a second computerized database, wherein the second computerized database is resident on or accessible by the first computer, and wherein the second computerized database further includes additional customer-specific information;
(f) a first premium quote, wherein the first premium quote is generated on the comparative rater based on the initial determinations of customer desirability and eligibility;
(g) at least one algorithm running on the first computer, wherein the at least one algorithm is operative to create a customer-specific profile, wherein the customer-specific profile is derived from the acquired customer-specific information and agent-specific criteria, and wherein the algorithm is further operative to compare the customer-specific profile to the set of tiered customer profiles to further determine customer fit; and
(h) an interstitial webpage running on the second computer, wherein the interstitial webpage is viewable by an individual using the comparative rater application, wherein the interstitial webpage is operative to provide subsequent premium quote variations, wherein the subsequent premium quote variations are based on customer fit as determined by the comparison of the customer-specific profile to the set of tiered customer profiles; and wherein the interstitial webpage is further operative to facilitate closing the sale of an insurance policy, wherein the policy premiums for the policy are selected from the subsequent premium quote variations.

2. The system of claim 1, wherein the first and second computers each include at least one server, and wherein the at least one server is in communication with the Internet or other internal or external networks.

3. The system of claim 1, wherein the insurance policy is an automobile policy.

4. The system of claim 1, wherein the insurance policy is a homeowner policy.

5. The system of claim 1, wherein the tiered customer profiles are operative to provide a determination of insurance policy coverage options; level of insurance risk; likelihood of insurance policy issuance; expected longevity of an insurance policy; or combinations thereof.

6. The system of claim 1, wherein the standardized customer characteristics are derived from compiled historical information that is not specific to a particular customer and that further includes: age of a person applying for coverage; current limits of insurance coverage for a person applying for coverage; number of vehicles to be insured; number of drivers to be listed on a policy; type of coverage requested; replacement value of a home; or combinations thereof.

7. The system of claim 1, wherein the predetermined agent criteria further includes: the number of new insurance policies written in a known period of time; the profile of new business policies issued by a particular company; the ratio of new policies bound by the agent relative to quotes submitted to a particular company over a known period of time; or combinations thereof.

8. The system of claim 1, wherein the customer specific-information relates directly to the individual customer seeking insurance coverage and further includes: the age of the person applying for coverage; the current limits of insurance coverage for the person applying for coverage; the number of vehicles to be insured; the number of drivers to be listed on a policy; the type of coverage requested; the replacement value of a home; or combinations thereof.

9. The system of claim 3, wherein the initial determination of customer desirability includes a determination of the number of vehicles being insured; the type of coverage and limits selected; or combinations thereof.

10. The system of claim 3, wherein the initial determination of customer eligibility includes a determination of an insured's age, vehicles being rated, coverage limits, prior insurance history, driving record, garaging location, or combinations thereof.

11. The system of claim 1, wherein the additional customer-specific information relates directly to the individual customer seeking insurance coverage and further includes information obtained from one or more external sources that is then used to create an insurance score for that customer, and wherein that insurance score is used in calculating the first premium quote.

12. The system of claim 1, wherein the at least one algorithm leverages the standardized customer characteristics, agent-specific criteria and additional customer-specific information to score an applicant for identifying suitable coverage options.

13. The system of claim 1, wherein the customer-specific profile includes likely coverage options; level of insurance risk; likelihood of policy issuance; expected longevity of the policy; or combinations thereof.

14. A computerized method for generating variable or adjustable quotes for insurance premiums and providing those quotes to a customer applying for insurance coverage, comprising:
(a) within a computerized database, creating tiered customer profiles, wherein each customer profile is based on standardized customer characteristics and on certain predetermined agent-specific criteria;
(b) acquiring customer-specific information, wherein the customer-specific information further includes desired insurance policy coverage options, and wherein the customer-specific information is acquired from data entered into a comparative rater application;
(c) applying at least one filter to the acquired customer-specific information, wherein the at least one filter is operative to provide an initial determination of customer desirability;
(d) applying at least one filter to the acquired customer-specific information, wherein at least one filter is functioning to provide an initial determination of customer eligibility;
(e) acquiring additional customer-specific information, wherein the customer-specific information is acquired from at least one database external to the comparative rater application;
(f) offering a first premium quote on the comparative rater based on the initial determinations of customer desirability and eligibility;
(g) using at least one algorithm to create a customer-specific profile, wherein the customer-specific profile is derived from the acquired customer-specific information and agent-specific criteria;
(h) comparing the customer-specific profile to the set of tiered customer profiles to further determine customer fit;
(i) providing an interstitial webpage, wherein the interstitial webpage is viewable by an individual using the comparative rater application;
(j) providing subsequent premium quote variations on the interstitial webpage, wherein the subsequent premium quote variations are based on customer fit as determined by the comparison of the customer-specific profile to the set of tiered customer profiles; and
(k) optionally, closing the sale of an insurance policy, wherein the policy premiums for the insurance policy are selected from the subsequent premium quote variations.

15. The method of claim 14, wherein the insurance policy is an automobile policy.

16. The method of claim 14, wherein the insurance policy is a homeowner policy.

17. The method of claim 14, wherein the tiered customer profiles are operative to provide a determination of insurance policy coverage options; level of insurance risk; likelihood of insurance policy issuance; expected longevity of an insurance policy; or combinations thereof.

18. The method of claim 14, wherein the standardized customer characteristics are derived from compiled historical information that is not specific to a particular customer and that further includes: age of a person applying for coverage; current limits of insurance coverage for a person applying for coverage; number of vehicles to be insured; number of drivers to be listed on a policy; type of coverage requested; replacement value of a home; or combinations thereof.

19. The method of claim 14, wherein the predetermined agent criteria further includes: the number of new insurance policies written in a known period of time; the profile of new business policies issued by a particular company; the ratio of new policies bound by the agent relative to quotes submitted to a particular company over a known period of time; or combinations thereof.

20. The method of claim 14, wherein the customer specific-information relates directly to the individual customer seeking insurance coverage and further includes: the age of the person applying for coverage; the current limits of insurance coverage for the person applying for coverage; the number of vehicles to be insured; the number of drivers to be listed on a policy; the type of coverage requested; the replacement value of a home; or combinations thereof.

21. The method of claim 15, wherein the initial determination of customer desirability includes a determination of the number of vehicles being insured; the type of coverage and limits selected; or combinations thereof.

22. The method of claim 15, wherein the initial determination of customer eligibility includes a determination of an insured's age, the vehicles being rated, coverage limits, prior insurance history, driving record, garaging location, or combinations thereof.

23. The method of claim 14, wherein the additional customer-specific information relates directly to the individual customer seeking insurance coverage and further includes information obtained from one or more external sources that is then used to create an insurance score for that customer, and wherein that insurance score is used in calculating the first premium quote.

24. The method of claim 14, wherein the at least one algorithm leverages the standardized customer characteristics, agent-specific criteria and additional customer-specific information to score an applicant for identifying suitable coverage options.

25. The method of claim 14, wherein the customer-specific profile includes likely coverage options; level of insurance risk; likelihood of policy issuance; expected longevity of the policy; or combinations thereof.

26. A computerized method for generating variable quotes for insurance premiums and providing those quotes to a customer applying for insurance coverage, comprising:
(a) within a computerized database, creating tiered customer profiles, wherein each customer profile is based on standardized customer characteristics and on certain predetermined agent-specific criteria, and wherein the tiered customer profiles are operative to provide a determination of insurance policy coverage options; level of insurance risk; likelihood of insurance policy issuance; expected longevity of an insurance policy; or combinations thereof;
(b) acquiring customer-specific information, wherein the customer-specific information further includes desired insurance policy coverage options, and wherein the customer-specific information is acquired from data entered into a comparative rater application;
(c) applying at least one filter to the acquired customer-specific information, wherein the at least one filter is operative to provide an initial determination of customer desirability;
(d) applying at least one filter to the acquired customer-specific information, wherein at least one filter is functioning to provide an initial determination of customer eligibility;
(e) acquiring additional customer-specific information, wherein the additional customer-specific information relates directly to the individual customer seeking insurance coverage and further includes information obtained from one or more external sources that is then used to create an insurance score for that customer, and wherein that insurance score is used in calculating a first premium quote;
(f) offering a first premium quote on the comparative rater based on the initial determinations of customer desirability and eligibility;
(g) using at least one algorithm to create a customer-specific profile, wherein the customer-specific profile is derived from the acquired customer-specific information and agent-specific criteria; and wherein the at least one algorithm leverages the standardized customer characteristics, agent-specific criteria and additional customer-specific information to score an applicant for identifying suitable coverage options;
(h) comparing the customer-specific profile to the set of tiered customer profiles to further determine customer fit;
(i) providing an interstitial webpage, wherein the interstitial webpage is viewable by an individual using the comparative rater application;
(j) providing subsequent premium quote variations on the interstitial webpage, wherein the subsequent premium quote variations are based on customer fit as determined by the comparison of the customer-specific profile to the set of tiered customer profiles; and
(k) optionally, closing the sale of an insurance policy, wherein the policy premiums for the insurance policy are selected from the subsequent premium quote variations.

27. The method of claim 26, wherein the insurance policy is an automobile policy.

28. The method of claim 26, wherein the insurance policy is a homeowner policy.

29. The method of claim 26, wherein the standardized customer characteristics are derived from compiled historical information that is not specific to a particular customer and that further includes: age of a person applying for coverage; current limits of insurance coverage for a person applying for coverage; number of vehicles to be insured; number of drivers to be listed on a policy; type of coverage requested; replacement value of a home; or combinations thereof.

30. The method of claim 26, wherein the predetermined agent criteria further includes: the number of new insurance policies written in a known period of time; the profile of new business policies issued by a particular company; the ratio of new policies bound by the agent relative to quotes submitted to a particular company over a known period of time; or combinations thereof.

31. The method of claim 26, wherein the customer specific-information relates directly to the individual customer seeking insurance coverage and further includes: the age of the person applying for coverage; the current limits of insurance coverage for the person applying for coverage; the number of vehicles to be insured; the number of drivers to be listed on a policy; the type of coverage requested; the replacement value of a home; or combinations thereof.

32. The method of claim 27, wherein the initial determination of customer desirability includes a determination of the number of vehicles being insured; the type of coverage and limits selected; or combinations thereof.

33. The method of claim 27, wherein the initial determination of customer eligibility includes a determination of an insured's age, the vehicles being rated, coverage limits, prior insurance history, driving record, garaging location, or combinations thereof.

34. The method of claim 26, wherein the customer-specific profile includes likely coverage options; level of insurance risk; likelihood of policy issuance; expected longevity of the policy; or combinations thereof.
